(19) United States
(12) Patent Application Publication
(10) Pub. No.: US 2026/0307828 A1
(43) Pub. Date: Oct. 8, 2026

(54) Spotlight Attachment For UAVS And Related Methods

(71) Applicant: Skydio, Inc., San Mateo, CA (US)

(72) Inventors: Vivian Zhou, San Mateo, CA (US); Jesse Wyatt Hansen, San Mateo, CA (US); Benjamin Scott Thompson, San Carlos, CA (US); Tamanna Nabar, Mountain View, CA (US)

(21) Appl. No.: 19/214,624

(22) Filed: May 21, 2025

Related U.S. Application Data
(60) Provisional application No. 63/650,077, filed on May 21, 2024.

(51) Int. Cl. B64U 20/80; B64U 10/14; B64U 101/00; F21V 14/02; G05D 1/689; G05D 109/25

(52) U.S. Cl. CPC B64U 20/80; B64U 10/14; F21V 14/02; G05D 1/689; B64U 2101/00; B64U 2201/10; B64U 2201/20; G05D 2109/254

(57) ABSTRACT

A spotlight attachment for unmanned aerial vehicles (UAVs) is designed to deliver illumination exceeding 5500 lumens, enabling the identification of objects or persons at distances greater than 100 meters. The system includes an intelligent modulation system that autonomously adjusts the luminous output and operational parameters based on real-time environmental conditions such as heat, wind, and battery status. Additionally, the spotlight features adjustable angles that can be pre-set or dynamically adjusted during operation. An autonomous tracking system centers the spotlight beam on selected static or moving targets, adjusting the UAV's flight parameters to maintain precise alignment. The system also allows for dynamic real-time adjustments of spotlight pitch and attachment positioning through onboard controls, remote mechanisms, or autonomous systems responding to sensor feedback.

### CROSS-REFERENCE TO RELATED APPLICATION(S)

This application claims the benefit of U.S. Provisional Patent Application No. 63/650,077, filed May 21, 2024, the entire disclosure of which is hereby incorporated by reference.

### TECHNICAL FIELD

The present disclosure relates to a spotlight attachment for UAVs, and more particularly, to a spotlight attachment designed for UAV integration with capabilities for adjustable illumination and automated tracking.

### BACKGROUND

Unmanned Aerial Vehicles (UAVs), commonly known as drones, have become increasingly prevalent in various sectors due to their versatility and ability to access hard-to-reach areas. These devices are employed in numerous applications ranging from recreational use to critical operations such as search and rescue, law enforcement, and infrastructure monitoring. The integration of advanced technologies into UAVs has expanded their functionality, allowing them to perform complex tasks that were previously challenging or impossible. One of the key areas of development in UAV technology is enhancing their operational capabilities through the addition of specialized attachments and systems.

In particular, the need for effective illumination solutions in UAV operations has become apparent, especially in scenarios requiring visibility in low-light conditions. Traditional lighting systems often fall short in providing the necessary brightness and adaptability required for dynamic environments. As UAVs are increasingly used in night-time operations, search and rescue missions, and surveillance tasks, there is a growing demand for lighting systems that can offer high luminosity, flexibility in direction, and adaptability to changing conditions. This demand drives the innovation of new lighting attachments that can seamlessly integrate with UAVs, providing enhanced operational efficiency and effectiveness.

### SUMMARY

The spotlight attachment for an unmanned aerial vehicle (UAV) may include a spotlight capable of delivering illumination exceeding 5500 lumens, which can help identify objects or persons at distances greater than 100 meters. The attachment can also feature an intelligent modulation system that may autonomously adjust the luminous output and operational parameters of the spotlight based on real-time environmental conditions such as heat, wind, and battery status.

Some examples of the spotlight attachment may include adjustable spotlight angles that can be manually pre-set before flight or dynamically adjusted remotely during UAV operation.

The spotlight attachment may also have an autonomous tracking system that can center a spotlight beam on selected static locations or dynamically moving targets. The system may adjust the flight parameters of the UAV to maintain precise spotlight alignment on these targets.

The autonomous tracking system may be configured to select static locations or dynamically moving targets through user inputs or automated algorithms.

The flight parameters that the autonomous tracking system can adjust may include the altitude, position, and orientation of the UAV.

A dynamic adjustment system may be part of the spotlight attachment, allowing for real-time adjustments of the spotlight pitch and attachment positioning.

The dynamic adjustment system may include onboard controls, remote control mechanisms, or autonomous onboard systems that respond to sensor feedback and environmental data.

An unmanned aerial vehicle (UAV) system may comprise a UAV and a spotlight attachment. The spotlight attachment can include a spotlight capable of delivering illumination exceeding 5500 lumens and an intelligent modulation system that may autonomously adjust the luminous output and operational parameters based on real-time environmental conditions.

The UAV system may also feature adjustable spotlight angles that can be manually pre-set before flight or dynamically adjusted remotely during UAV operation.

An autonomous tracking system in the UAV system may center a spotlight beam on selected static locations or dynamically moving targets and adjust the UAV's flight parameters to maintain precise spotlight alignment.

The autonomous tracking system in the UAV system may select static locations or dynamically moving targets through user inputs or automated algorithms.

The flight parameters in the UAV system that can be adjusted may include the altitude, position, and orientation of the UAV.

A dynamic adjustment system in the UAV system may allow for real-time adjustments of the spotlight pitch and attachment positioning.

The dynamic adjustment system in the UAV system may include onboard controls, remote control mechanisms, or autonomous onboard systems that respond to sensor feedback and environmental data.

A method for illuminating objects or persons using a UAV may involve delivering illumination exceeding 5500 lumens by a spotlight attached to the UAV to identify objects or persons at distances greater than 100 meters. The method can also include autonomously adjusting the luminous output and operational parameters of the spotlight based on real-time environmental conditions.

The method may further involve manually pre-setting or dynamically adjusting the spotlight angles before flight or remotely during UAV operation.

The method can also include centering a spotlight beam on selected static locations or dynamically moving targets and adjusting the UAV's flight parameters to maintain precise spotlight alignment.

The method may further involve selecting static locations or dynamically moving targets through user inputs or automated algorithms.

The flight parameters in the method that can be adjusted may include the altitude, position, and orientation of the UAV.

The method may also allow for dynamic real-time adjustments of the spotlight pitch and attachment positioning, with the dynamic adjustment system comprising onboard controls, remote control mechanisms, or autonomous onboard systems responding to sensor feedback and environmental data.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 is a top perspective view of an exemplary UAV in accordance with various embodiments.

FIG. 2 is a bottom perspective view of the UAV of FIG. 1 in accordance with various embodiments.

FIG. 3A is a close-up perspective view of the UAV of FIG. 1 in accordance with various embodiments.

FIG. 3B is the close-up perspective view of FIG. 3A having a housing of the UAV removed in accordance with various embodiments.

FIG. 4 is a close-up view of another attachment interface of the UAV of FIG. 1 in accordance with various embodiments.

FIG. 5 is a side view of the UAV of FIG. 1 in accordance with various embodiments.

FIG. 6 is another side view of the UAV of FIG. 1 in accordance with various embodiments.

FIG. 7 illustrates a UAV spotlight system with intelligent modulation and autonomous tracking capabilities in accordance with various embodiments.

FIG. 8 illustrates, in a flowchart, operations for enhancing UAV spotlight functionality for dynamic and autonomous illumination control in accordance with various embodiments.

FIG. 9 illustrates an example UAV architecture for a UAV in accordance with various embodiments.

### DETAILED DESCRIPTION

The disclosure provides a spotlight attachment for UAVs, which may deliver illumination exceeding 5500 lumens to identify objects or persons at distances greater than 100 meters. The spotlight may feature adjustable angles that can be manually pre-set before flight or dynamically adjusted remotely during UAV operation. An intelligent modulation system may autonomously adjust the luminous output and operational parameters of the spotlight based on real-time environmental conditions, such as heat, wind, and battery status. The system may include an autonomous tracking system that centers the spotlight beam on selected static locations or dynamically moving targets, adjusting UAV flight parameters like altitude, position, and orientation to maintain precise spotlight alignment. The dynamic adjustment system may allow real-time adjustments of spotlight pitch and attachment positioning through onboard controls, remote control mechanisms, or autonomous onboard systems responding to sensor feedback and environmental data. This setup can be used in various applications, including search and rescue operations, law enforcement surveillance, emergency response scenarios, security monitoring of infrastructure, and recreational and commercial UAV operations.

The spotlight attachment for an unmanned aerial vehicle (UAV) may be configured to deliver illumination exceeding 5500 lumens, potentially allowing for the identification of objects or persons at distances greater than 100 meters. The spotlight may comprise adjustable spotlight angles, which can be manually pre-set before flight or dynamically adjusted remotely during UAV operation. This configuration may facilitate the adjustment of light direction to suit various operational needs. The spotlight attachment may also incorporate an intelligent modulation system, which may autonomously adjust the luminous output and operational parameters based on real-time environmental conditions, such as heat, wind, and battery status. This autonomous adjustment may ensure performance and energy efficiency under varying conditions. The spotlight's ability to deliver high-intensity light and its adjustable angles may be beneficial for applications requiring precise illumination, such as search and rescue operations or law enforcement surveillance. The integration of these features may enhance the UAV's capability to perform effectively in diverse scenarios, potentially improving the identification and tracking of targets from significant distances.

The intelligent modulation system may be configured to autonomously adjust the luminous output and operational parameters of the spotlight based on real-time environmental conditions. This adjustment may be influenced by factors such as heat, wind, and battery status. The system may incorporate intelligent modulation to respond to these environmental changes, potentially enhancing the spotlight's performance. The luminous output and operational parameters may be adjusted to optimize the spotlight's functionality under varying conditions. The intelligent modulation system may work in conjunction with the UAV's other systems to ensure efficient operation. The autonomous adjustment of the luminous output may be important for maintaining the desired level of illumination, especially in challenging environmental conditions. The system may also consider the battery status to manage power consumption effectively. The integration of these features may allow the UAV to perform its tasks with precision and reliability. The intelligent modulation system may be a component in achieving the desired outcomes for the UAV's spotlight attachment.

According to an embodiment, the UAV may be equipped with an autonomous tracking system that can be configured to select static locations or dynamically moving targets via user inputs or automated algorithms. This system may be designed to center a spotlight beam on the selected static locations or dynamically moving targets. The UAV's flight parameters, which may include altitude, position, and orientation, can be adjusted to maintain precise spotlight alignment on these targets. The autonomous tracking system may enable the UAV to autonomously center the spotlight beam, potentially enhancing target tracking capabilities. The UAV's flight parameters may be specified to ensure that the spotlight remains aligned with the target, thereby facilitating continuous illumination. The autonomous tracking system may be integrated with the UAV to allow for seamless operation, potentially improving the UAV's ability to track and illuminate targets effectively.

According to an embodiment, the dynamic adjustment system may be configured to allow dynamic real-time adjustments of spotlight pitch and attachment positioning. This may be achieved through the incorporation of onboard controls, remote control mechanisms, or autonomous onboard systems. These systems may respond to sensor feedback and environmental data, enabling the spotlight to adjust its pitch and positioning dynamically. The dynamic adjustment system may comprise at least one of these control mechanisms, allowing for flexibility in operation. The spotlight pitch and attachment positioning may be adjusted in real-time, potentially enhancing the UAV's ability to maintain illumination on targets. The system may utilize environmental data to inform these adjustments, ensuring that the spotlight remains effective under varying conditions. The integration of sensor feedback may further refine the adjustments, allowing for control over the spotlight's orientation and positioning. This capability may be particularly beneficial in scenarios where the UAV is required to adapt to changing environmental conditions or target movements. The dynamic adjustment system may thus provide a solution for maintaining illumination in diverse operational contexts.

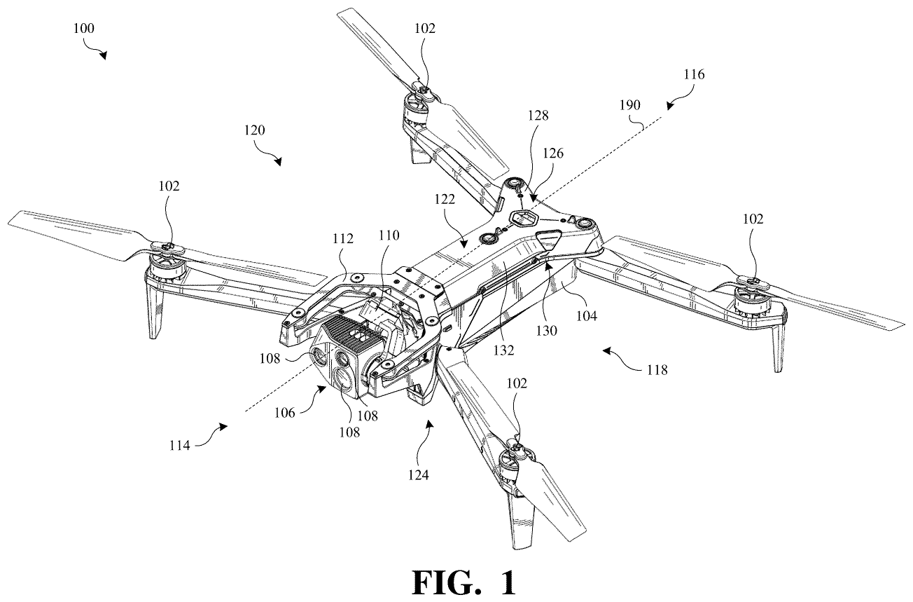

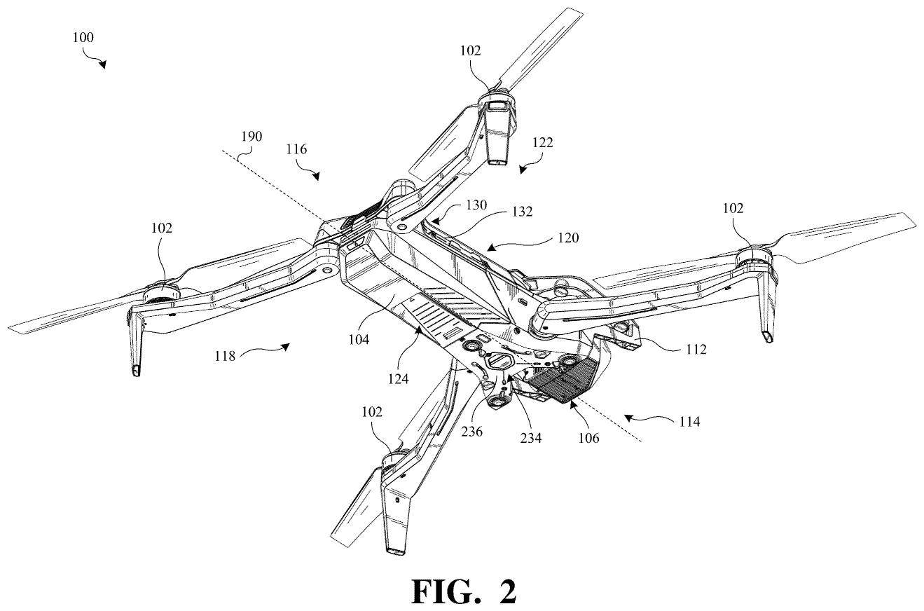

Turning now to the figures, FIG. 1 illustrates a top perspective view of an unmanned aerial vehicle (UAV) 100. FIG. 2 illustrates a bottom perspective view of the UAV 100.

The UAV 100 may include one or more propulsion mechanisms 102 and a power source, such as a battery coupled to the UAV 100. The UAV 100 may be configured for autonomous landing and/or docking with a docking station. To support the autonomous landing and/or docking, the UAV 100 may follow any suitable processes or procedures, or may include one or more components, such as those described in U.S. application Ser. No. 16/991,122, filed Aug. 12, 2020, and U.S. Provisional Application No. 63/527,261, filed on Jul. 17, 2023, the entire disclosures of which are hereby incorporated by reference for all purposes.

The propulsion mechanisms 102 may include any components and/or structures suitable for supporting flight of the UAV 100. For example, as shown in FIGS. 1 and 2, the propulsion mechanisms 102 may be or may include propeller assemblies having one or more blades connected to hubs of the UAV 100. The one or more blades may be propelled by a motor to rotate the one or more blades and facilitate flight of the UAV 100, whereby the motor may be powered by a power source of the UAV 100, such as the battery 104. It should be appreciated, however, that the configuration and/or structure of the UAV 100 may vary depending on the particular configuration of the UAV 100, and as such, the UAV 100 shown in FIG. 1 is not intended to limit the structure of the UAV 100.

As mentioned above, the UAV 100 may be configured using various processes or protocols to autonomously land (e.g., on a docking station), to autonomously take flight (e.g., from a docking station), or both. To facilitate autonomous landing and/or autonomous flight, the UAV 100 may include one or more sensors, such as image sensors, that are configured to monitor a position of the UAV 100 and/or detect a specified image, such as a fiducial disposed on a docking station. For example, during a landing sequence (e.g., a docking sequence) of the UAV 100, the image sensors of the UAV 100 may detect an image, such as the fiducial disposed on the docking station, to properly align and guide the UAV 100 to dock.

The UAV 100 may further include a camera system 106. The camera system 106 may be configured to detect, monitor, capture, record, or a combination thereof one or more images. The camera system 106 may be configured to facilitate autonomous or user-controlled flight of the UAV 100. For example, the camera system 106 may include one or more cameras 108. The cameras 108 may capture a live feed of an environment during flight, whereby a user via a user interface (e.g., a controller) may control the UAV 100 based upon the live feed of the environment. Alternatively, or additionally, the cameras 108 may capture images of the environment and/or monitor the environment in real-time to autonomously fly through the environment. It should be noted that the cameras 108 and the camera system 106 are not limited to any particular configuration, and any types of camera configurations (e.g., wide-angle, high-resolution, etc.) may be implemented in the UAV 100.

The camera system 106 may be operable via a gimbal system 110 coupled to the camera system 106. The gimbal system 110 may be configured to be controlled autonomously or via a user interface (e.g., a controller) to orient or otherwise move the camera system 106 (e.g., the cameras 108) relative to the UAV 100. The gimbal system 110 may include one or more arms and one or more pivot joints that facilitate movement of the camera system 106 relative to the UAV 100.

The gimbal system 110 and the camera system 106 may be coupled to the UAV 100 by a mounting bracket 112. The mounting bracket 112 may be coupled to the UAV 100 by one or more fasteners or other mechanical connection means to secure the gimbal system 110 and the camera system 106 to the UAV 100. The mounting bracket 112 may be coupled to any portion of the UAV 100. By way of example, as shown in FIGS. 1 and 2, the mounting bracket 112 may be coupled to a front 114 (i.e., a front side) of the UAV 100 or a top 122 (i.e., a top side) of the UAV 100 such that the camera system 106 may be positioned in the front 114 of the UAV 100.

That is, the camera system 106 may be located at the front 114 (i.e., the front side) of the UAV 100 so that the cameras 108 may capture an environment in front of the UAV 100 with respect to a forward direction of travel of the UAV 100 (e.g., a direction of travel of the UAV 100 that is substantially parallel to the ground or along the ground). However, in certain configurations, the camera system 106 may also be coupled to another portion of the UAV 100, such as a rear 116 (i.e., rear side) of the UAV 100, a first side 118 of the UAV 100, a second side 120 of the UAV 100, a bottom 124 (i.e., a bottom side) of the UAV 100, or a combination or variation thereof.

As discussed in further detail below, one or more attachments may be coupled to the UAV 100 and operable with the UAV 100 to further customize a user experience of the UAV 100. That is, the one or more attachments may be coupled to the UAV 100 to provide additional functionality to the UAV 100. For example, the one or more attachments may be a global positioning system (GPS) attachment, a microphone and/or speaker attachment, a night vision attachment (e.g., infrared (IR) attachment), a spotlight attachment, a secondary power source attachment (e.g., a secondary battery similar to the battery 104), an antenna or other radio accessory, a secondary camera system similar to or different from the camera system 106, a computer module, or a combination thereof. Thus, it is envisioned that any type of attachments or arrangement of multiple attachments may be configured for securement to the UAV 100. Additionally, as discussed in further detail below, the UAV 100 or a system thereof may be dynamic such that one or more characteristics (e.g., features, functionalities, operations, etc.) of the UAV 100 may be automatically and dynamically adjusted based upon a type of attachment coupled to the UAV 100.

To facilitate coupling one or more attachments to the UAV 100, the UAV 100 may include one or more attachment interfaces. As shown in FIGS. 1 and 2, the UAV 100 may include a plurality of attachment interfaces located on the UAV 100. For example, the UAV 100 may include a top attachment interface 126 located on the top 122 (i.e., the top side) of the UAV 100, a side attachment interface 130 located on the first side 118 of the UAV 100, a side attachment interface 130 located on the second side 120 of the UAV 100 that opposes the first side 118, and a bottom attachment interface 234 located on the bottom 124 (i.e., the bottom side) of the UAV 100.

To further illustrate positioning of such attachment interfaces, as shown in FIGS. 1 and 2, the UAV 100 (e.g., a body of the UAV 100 from which the propulsion mechanisms 102 extend) may extend along a longitudinal axis 190 of the UAV 100 from the front 114 of the UAV 100 to the rear 116 of the UAV 100. That is, the UAV 100 may extend from a first end (e.g., the front 114, which may be considered a forward end of the UAV 100) to an opposing second end (e.g., the rear 116, which may be considered an aft end of the UAV 100) along the longitudinal axis 190, whereby a length of the UAV 100 or a body thereof may be measured from the first end to the second end.

Moreover, the first side 118 of the UAV 100 may oppose the second side 120 of the UAV 100 with respect to the longitudinal axis 190. The first side 118 and second side 120 may be located on opposing sides of the longitudinal axis 190. The first side 118 may be considered a port side of the UAV 100 and the second side 120 may be considered a starboard side of the UAV 100.

Based on the above relative orientations, it can be seen in FIGS. 1 and 2 that the attachment interfaces described above may be positioned in various locations with respect to the longitudinal axis 190 of the UAV 100. For example, the top attachment interface 126 and/or the bottom attachment interface 234 may be located on the top 122 (i.e., the top side) of the UAV 100 and may extend along the longitudinal axis 190 between the first end (e.g., the front 114 or forward end) and the second end (e.g., the rear 116 or aft end) of the UAV 100. Additionally, the side attachment interfaces 130 may be located on the first side 118 and the second side 120 of the UAV 100 such that the side attachment interfaces 130 may be located on opposing sides of the longitudinal axis 190. That is, a first one of the side attachment interfaces 130 may be located on the port side (e.g., the first side 118) of the UAV 100 and a second one of the side attachment interfaces 130 may be located on the starboard side (e.g., the second side 120) of the UAV 100 such that the side attachment interfaces 130 are located on opposing sides of the longitudinal axis 190.

It should be noted that the above relative orientations associated with the UAV 100 are provided for illustrative purposes and should not be construed as limiting the teachings herein. For example, although the front 114 of the UAV 100 may be considered the front end of the UAV 100 and the rear 116 of the UAV 100 may be considered the aft end of the UAV 100, such considerations do not mean that the UAV 100 only travels in a forward direction with the front 114 of the UAV 100 leading the travel. That is, the UAV 100 may travel in any direction (e.g., fore, aft, side-to-side between the port and starboard sides, in an elevational direction, etc.) with respect to the longitudinal axis 190.

Turning now back to the attachment interfaces, it should be noted that such attachment interfaces may be integrated into the UAV 100, such as a housing of the UAV 100, or may be connected to the UAV 100 to allow for attachment of various attachments. That is, the attachment interfaces may provide a connection means to easily and removably couple various attachments to the UAV 100.

By way of example, the top attachment interface 126 may include a top attachment surface 128. The top attachment surface 128 may be located on, or formed with, the top (i.e., the top side) of the UAV 100. The top attachment surface 128 may be configured to receive, support, or otherwise couple to—either directly or indirectly—various attachments. Similarly, the side attachment interfaces 130 may include a side attachment surface 132 located on, or formed with, the first side 118 and/or the second side 120 of the UAV 100. Moreover, the bottom attachment interface 234 may include a bottom attachment surface 236 located on, or formed with, the bottom 124 (i.e., the bottom side) of the UAV 100. Any number of these attachment surfaces may exist for any of the attachment interfaces. That is, an attachment interface may include more than one attachment surface (e.g., a first attachment surface and a second attachment surface).

Based on the above, one or more attachments may be coupled to the top 122 of the UAV 100, the bottom 124 of the UAV 100, the first side 118 of the UAV 100, the second side 120 of the UAV 100, or a combination thereof. Additionally, it is envisioned that the front 114 and/or the rear 116 of the UAV 100 may also in certain configurations include an additional attachment interface. For example, in certain configurations the UAV 100 may remove the camera system 106 from the front 114 of the UAV and couple the camera system 106 to the UAV 100 in another location (e.g., the rear 116). In such a configuration, the front 114 may include an attachment interface for further attachments.

It should also be noted that the attachment interfaces of the UAV 100 may be adapted for universal or common attachment techniques. That is, various types of attachments may be coupled to the same attachment interface. For example, the GPS attachment and the night vision attachment may both be configured to attach to the top attachment interface 126 and the bottom attachment interface 234. Additionally, more than one attachment may be coupled to the UAV 100 at one time and may be powered by the power source (e.g., the battery 104) of the UAV 100. For example, a first attachment (e.g., a GPS attachment) may be coupled to the top attachment interface 126 and a second attachment (e.g., a spotlight attachment) may be coupled to the side attachment interface 130 located on the first side 118 of the UAV 100. Moreover, the attachment interfaces may include one or more additional features, such as heat-sinking components or other cooling components. Based on the above, various configurations and customization may be possible based on the teachings herein.

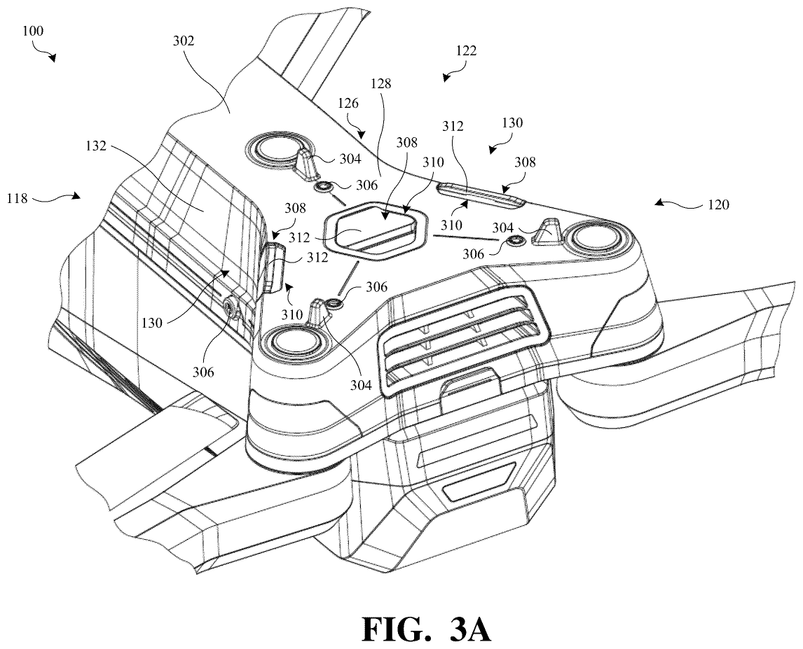

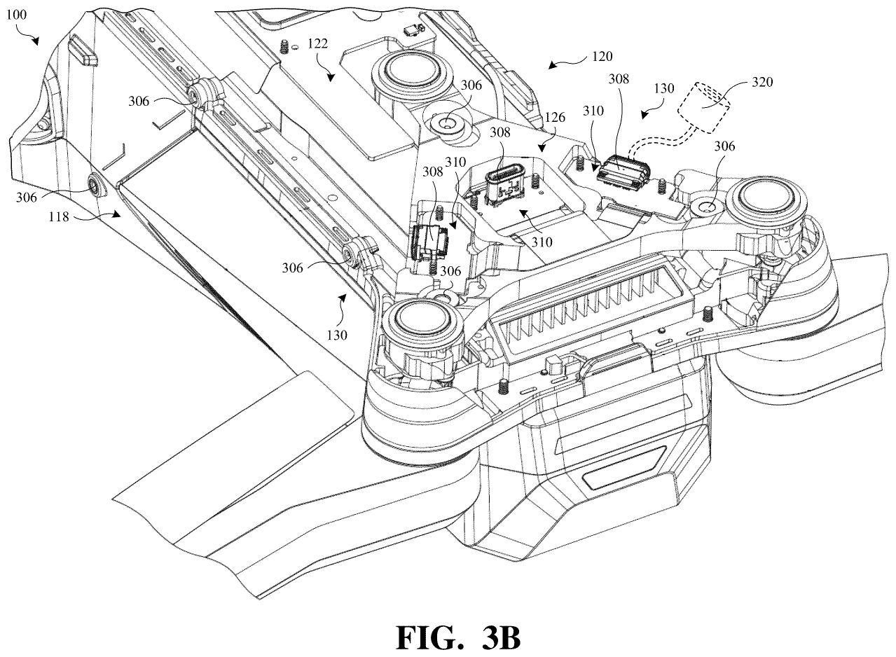

FIG. 3A illustrates a close-up perspective view of the UAV 100 of FIG. 1. FIG. 3B illustrates another close-up perspective view of the UAV 100 of FIG. 1 with a housing 302 of the UAV 100 removed for further illustration. As discussed above, the UAV 100 may include one or more attachment interfaces, such as the top attachment interface 126 located on the top 122 (i.e., the top side) of the UAV 100 and the side attachment interface 130 located on the first side 118 of the UAV 100, as shown in FIGS. 3A and 3B.

The attachment interfaces (e.g., the top attachment interface 126, the side attachment interfaces 130, the bottom attachment interface 234, etc.) of the UAV 100 may be coupled to or formed with a portion of the UAV 100. By way of example, as discussed above, the attachment interfaces may include an attachment surface configured to receive or otherwise couple to the various attachments. For example, the top attachment interface 126 may include the top attachment surface 128 and the side attachment interface 130 of the first side 118 of the UAV 100 may include the side attachment surface 132.

Such attachment surfaces may be coupled to the housing 302 of the UAV 100 or may integrally formed with the housing 302. That is, the housing 302 may be considered an outer shell or outer casing of the UAV 100 that defines one or more interior compartments of the UAV 100, whereby the interior compartments may substantially contain various components (e.g., electrical components, mechanical components, etc.) of the UAV 100. As shown in FIG. 3A, the top attachment surface 128 may be formed with—or form a portion of—a top portion (e.g., surface) of the housing 302 located on the top 122 of the UAV 100. Similarly, the side attachment surface 132 may be formed with—or form a portion of—a first side (e.g., surface) of the housing 302 located on the first side 118 of the UAV 100. Therefore, the attachments may be coupled directly or indirectly to the housing 302 of the UAV 100 via the attachment surfaces.

To facilitate such coupling of various attachments, the top attachment interface 126 may include one or more projections 304. The projections 304 may be configured to align an attachment with the top attachment surface 128. For example, the projections 304 may define a perimeter, such as a perimeter of the top attachment surface 128 or a portion thereof, whereby the attachment may be coupled to the top attachment surface 128 such that the attachment is located within and/or along the perimeter. That is, the attachment may be encompassed by the perimeter.

Similarly, the projections 304 may aid with alignment between an attachment and the top attachment surface 128. For example, as described in further detail below, the attachments may be coupled to the top attachment surface 128 using one or more fasteners. The projections 304 may aid in aligning an attachment with mounting holes 306 of the top attachment interface 126 so that the one or more fasteners may extend through the attachment and into respective ones of the one or more fasteners. That is, the mounting holes 306 may be positioned within (e.g., encompassed by) the perimeter defined by the projections 304 so that, when the attachment is located within (e.g., encompassed by) the perimeter, the mounting holes 306 align with the attachment to facilitate coupling the attachment to the top attachment surface 128.

The projections 304 are not limited to any particular size or shape. The projections 304 may extend away from the top attachment surface 128 and/or away from the UAV 100. The projections 304 may extend generally orthogonally to the top attachment surface 128 or may at any angle with respect to the top attachment surface 128. The projections 304 may have any geometry so facilitate guiding and/or locating the attachments with respect to the top attachment surface 128. For example, the projections 304 may each include a tapered surface, whereby the tapered surfaces of the projections 304 converge toward one another (e.g., converge toward a center region of the perimeter defined by the projections 304).

As discussed above, the top attachment interface 126 may be configured to mechanically couple various attachments to the UAV 100. The attachments may be advantageously coupled to the top attachment surface 128 in a removably manner to facilitate interchangeability, removal, and replacement of the attachments. In addition to mechanically coupling the various attachments to the UAV 100, the top attachment surface 128 may also electrically couple the various attachments to the UAV 100.

The top attachment interface 126 may include one or more connector ports 308. The connector ports 308 may be located on, or formed in, the top attachment surface 128. The connector ports 308 may be configured to receive an electrical connector of the various attachments. For example, the connector ports 308 may be configured to receive a universal serial bus (USB) connector, such as a USB-C connector of the attachments. However, the connector ports 308 may be configured to receive any type of connector, such as USB-A, USB-B, micro-USB, mini-USB, high-definition multimedia interface (HDMI), audio jack, the like, or a combination thereof.

The connector ports 308 may be configured to electrically couple the various attachments to the UAV 100. That is, an electrical system of the various attachments may be in communication with the electrical system of the UAV 100. As such, the various attachments may be configured to communicate (e.g., transmit) information to the UAV 100, such as intrinsic information pertaining to the various attachments. Similarly, the UAV 100 may communicate (e.g., transmit) information to the various attachments. Additionally, the various attachments, via the connector ports 308, may be powered by a power source of the UAV 100, such as the battery 104. Thus, the various attachments may interface with the UAV 100 such that the attachments may be operable in conjunction with the UAV 100.

The connector ports 308 of the top attachment interface 126 may be positioned anywhere along the top attachment surface 128 or another surface of the UAV 100. The connector ports 308 may project from the top attachment interface 126 or may be recessed from the top attachment interface 126. For example, the connector ports 308 may be positioned in a recess 310 defined by the top attachment surface 128 or another surface of the UAV 100. As such, an outermost surface of the connector ports 308 may be recessed from the top attachment surface 128. It should also be noted that any number of connector ports 308 and/or recesses 310 may be located on the top attachment surface 128.

The connector ports 308 may also be protected by a cover 312 when not in use by an attachment. The cover 312 may prevent moisture, debris, debris, dust, dirt, other potential contaminants, or a combination thereof from entering the connector ports 308. The cover 312 may be removable or otherwise repositionable to facilitate coupling the connector of an attachment to the connector ports 308. The cover 312 may be used for more than one of the connector ports 308 or each of the connector ports 308 may have their own one of the covers 312. It should also be noted that the in addition to, or in lieu of, the cover 312, one or more of the connector ports 308 may also be protected by other types of weatherproofing, such as a gasket, a foam material, a sealant material, or a combination thereof.

In addition to the top attachment interface 126 described above, the UAV 100 may also include the side attachment interfaces 130 shown in FIGS. 3A and 3B. A first of the side attachment interfaces 130 may be located on the first side 118 of the UAV 100 and a second of the side attachment interfaces 130 may be located on the second side 120 of the UAV 100. The first of the side attachment interfaces 130 may include the side attachment surface 132 which may be coupled to, or integrally formed with, the first side 118 of the UAV 100 (e.g., coupled to or integrally formed with a portion of the housing 302 on the first side 118 of the UAV 100). Similarly, the second of the side attachment interfaces 130 may include the side attachment surface 132 which may be coupled to, or integrally formed with, the second side 120 of the UAV 100 (e.g., coupled to or integrally formed with a portion of the housing 302 on the second side 120 of the UAV 100). Thus, various attachments may be coupled to the first side 118 and/or the second side 120 of the UAV 100 in a similar or different manner compared to the top attachment interface 126.

By way of example, the side attachment interfaces 130 may include additional ones of the mounting holes 306 that may be located on the side attachment surfaces 132. The mounting holes 306 may be the same or different than the mounting holes 306 of the top attachment surface 128. For example, the mounting holes 306 of the side attachment interfaces 130 may be configured to receive fasteners (e.g., threaded fasteners) to couple the attachments to the side attachment surfaces 132. As such, a location of the mounting holes 306 and/or a geometry of the mounting holes 306 is not particularly limited.

The side attachment interfaces 130 may also include one or more of the connector ports 308. The connector ports 308 may be located on the side attachment surfaces 132. Alternatively, or additionally, the connector ports 308 may be located on another surface of the UAV 100, such as the top attachment surface 128. Thus, all or a portion of the connector ports 308 located on the top attachment surface 128 may be considered part of the top attachment interface 126 and/or the side attachment interfaces 130, thereby providing further flexibility when coupling attachments to the UAV 100.

For example, the top attachment surface 128 may include a plurality of the connector ports 308, whereby a centrally located one of the connector ports 308 may be positioned within (e.g., encompassed by) the perimeter of the projections 304 and configured to couple an attachment to the top attachment surface 128. Additionally, the top attachment surface 128 may include another pair of the connector ports 308 positioned outside of the perimeter of the projections 304. The pair of the connector ports 308 may be located on the top attachment surface 128 and be positioned adjacent to the side attachment surfaces 132. As such, the connector ports 308 may be configured to electrically couple an attachment, such as the attachment 320, to the UAV 100 so that the attachment 320 may be mechanically (e.g., removably) coupled to the side attachment surface 132 located on the first side 118 and/or the second side 120.

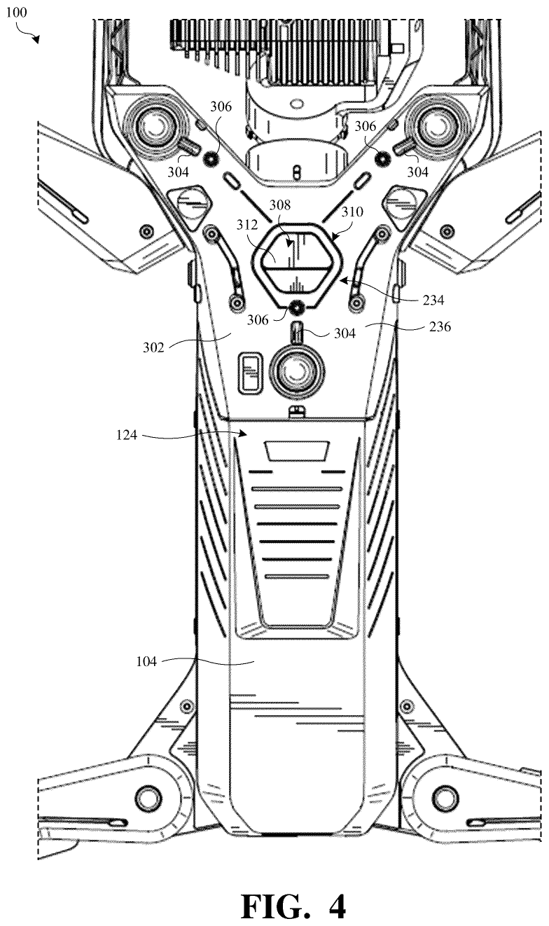

Based on the above, attachments such as the attachment 320 may be mechanically and/or electrically coupled to the first side 118, the second side 120, and the top 122 (i.e., the top side) of the UAV 100. Additionally, as shown in the close-up view of FIG. 4, the UAV 100 may also include the bottom attachment interface 234 to mechanically and/or electrically couple attachments to the bottom 124 (i.e., the bottom side) of the UAV 100.

As discussed above, the bottom attachment interface 234 may include the bottom attachment surface 236. The bottom attachment surface may be coupled to, or located on the bottom 124 (i.e., the bottom side) of the UAV 100. For example, the bottom attachment surface 236 may be coupled to, or integrally formed with, a portion of the housing 302 of the UAV 100 located on the bottom 124 of the UAV 100. The bottom attachment surface 236 may be positioned adjacent to and/or may abut the battery 104 of the UAV 100 so that an attachment coupled to the bottom attachment surface 236 may be free of obstruction of the battery 104.

The bottom attachment interface 234 may include one or more of the projections 304. The projections 304 of the bottom attachment interface 234 may be located on the bottom attachment surface 236. The projections 304 of the bottom attachment interface 234 may be similar to the projections 304 of the top attachment interface 126 as described above. For example, the projections 304 of the bottom attachment interface 234 may define a perimeter around or on the bottom attachment surface 236, whereby an attachment may be configured to be aligned and located within (e.g., encompassed by) and/or along the perimeter to couple the attachment to the bottom attachment surfaces 236 via one or more fasteners extending into mounting holes 306 of the bottom attachment interface 234. The mounting holes 306 may be similar to the mounting holes 306 described above.

The bottom attachment interfaces 234 may also electrically couple various attachments to the UAV 100 via another one of the connector ports 308 located on the bottom attachment surface 236. The connector port 308 of the bottom attachment interface 234 may be positioned within (e.g., encompassed by) the perimeter of the projections 304. For example, the mounting holes 306 may be located within (e.g., encompassed by) the perimeter of the projections 304 adjacent to the projections 304 and the connector port 308 may be located centrally within the perimeter of the projections 304. It should be noted that the connector port 308 may be similar to the connector ports 308 described above with respect to the top attachment interface 126 and the side attachment interfaces 130. For example, the connector port 308 of the bottom attachment interface 234 may be configured to receive a USB-C connector of an attachment.

The connector port 308 may be located anywhere along the bottom attachment surface 236. For example, the bottom attachment surface 236 may define a recess 310 similar to the recess 310 of the top attachment interface 126, whereby the connector port 308 may be located within the recess 310 of the bottom attachment surface 236. Thus, an attachment may be in electrical communication with the UAV 100 and may be powered by a power source of the UAV 100, such as the battery 104.

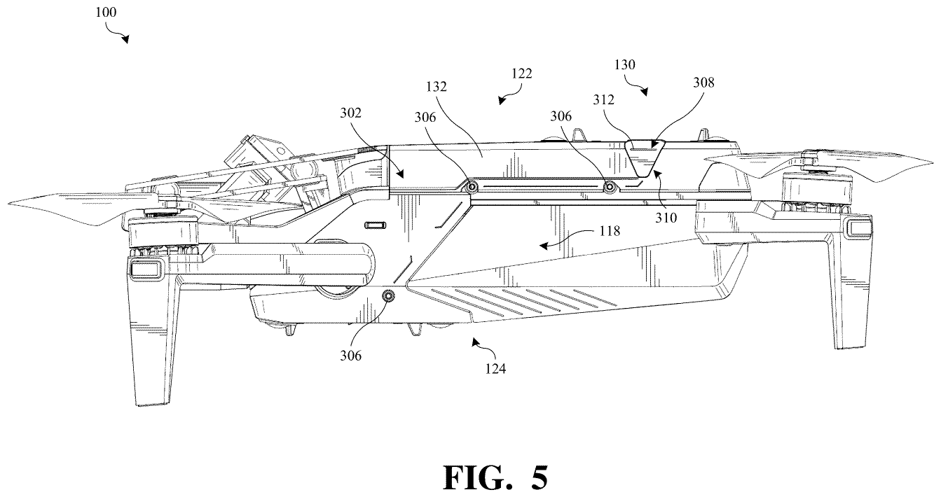

FIG. 5 illustrates a side view of the UAV 100 to further illustrate the side attachment interface 130 located on the first side 118 of the UAV 100. As described above, the side attachment interface 130 of the first side 118 may include the side attachment surface 132. The side attachment surface 132 may be coupled to, or formed with, a portion of the housing 302 that is located on the first side 118 of the UAV 100.

The side attachment interface 130 of the first side 118 may also include the mounting holes 306 located along the side attachment surface 132. The mounting holes 306 may be located anywhere along the side attachment surface 132 to removably couple attachments, such as the attachment 320 described above, to the first side 118. The side attachment interface 130 of the first side 118 may also include the connector port 308 to electrically couple attachments to the UAV 100. The connector port 308 may be located in the recess 310, whereby the recess 310 may be defined by the top attachment surface 128 and/or the side attachment surface 132 of the first side 118 (see FIGS. 3A and 3B). Based on the above configuration, an attachment, such as the attachment 320, may be coupled to the first side 118 of the UAV 100 and be free of obstruction of operation of the UAV 100 (e.g., the propulsion mechanisms 102 and/or the camera system 106 of the UAV 100).

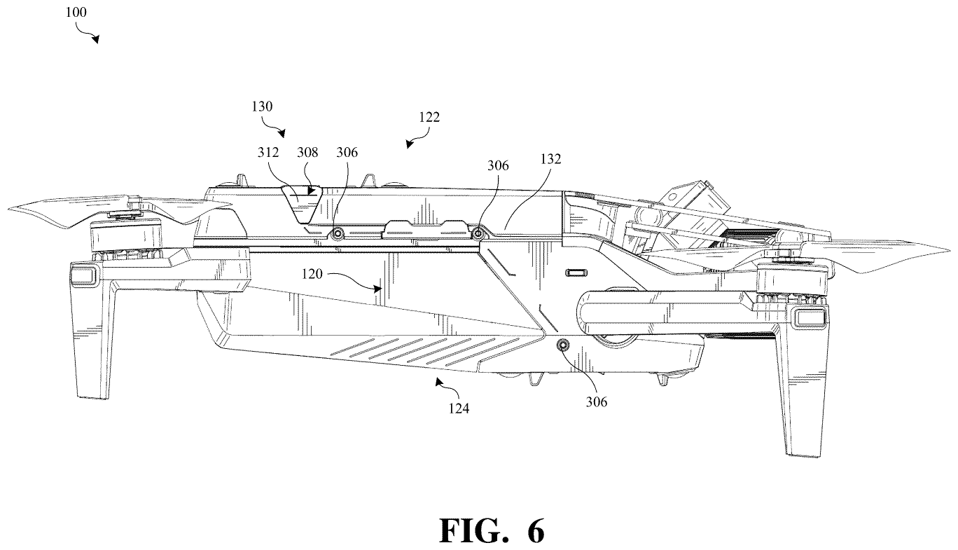

FIG. 6 illustrates a side view of the UAV 100 to further illustrate the side attachment interface 130 located on the second side 120 of the UAV 100. As described above, the side attachment interface 130 of the second side 120 may include the side attachment surface 132. The side attachment surface 132 may be coupled to, or formed with, a portion of the housing 302 that is located on the second side 120 of the UAV 100. The side attachment interface 130 located on the second side 120 may directly oppose the side attachment interface 130 located on the first side 118. That is, the side attachment interface 130 located on the second side 120 may be symmetrically opposite to the side attachment interface 130 located on the first side 118 or may differ in configuration.

The side attachment interface 130 of the second side 120 may also include the mounting holes 306 located along the side attachment surface 132. The mounting holes 306 may be located anywhere along the side attachment surface 132 to removably couple attachments, such as the attachment 320 described above, to the second side 120. The side attachment interface 130 of the second side 120 may also include the connector port 308 to electrically couple attachments to the UAV 100. The connector port 308 may be located in the recess 310, whereby the recess 310 may be defined by the top attachment surface 128 and/or the side attachment surface 132 of the second side 120. Based on the above configuration, an attachment, such as the attachment 320, may be coupled to the second side 120 of the UAV 100 and be free of obstruction of operation of the UAV 100 (e.g., the propulsion mechanisms 102 and/or the camera system 106 of the UAV 100).

The following paragraphs describe advanced circular heatsinks for a UAV-mounted high-powered spotlight may include a circular heatsink body and several radial fins extending uniformly from the body. These radial fins can be strategically arranged and have an aerodynamic profile to optimize airflow generated by a propulsion system of the UAV 100 during flight, thereby enhancing heat dissipation from the heatsink body.

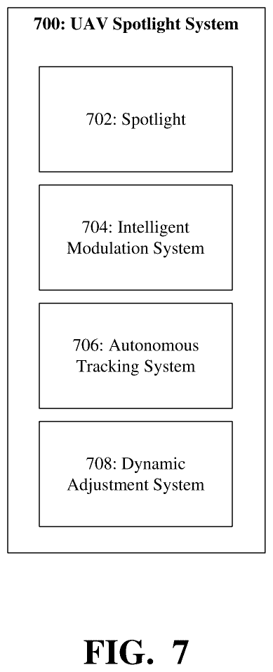

FIG. 7 illustrates the spotlight component 702, which may be integral to the UAV system. The spotlight component 702 may provide high-intensity illumination, potentially exceeding 5500 lumens, to identify objects or persons at distances greater than 100 meters. The spotlight may feature adjustable angles, which may be manually pre-set before flight or dynamically adjusted remotely during UAV operation. This capability may allow for illumination control, enhancing the UAV's operational flexibility. The spotlight component 702 may be associated with an intelligent modulation system, which may autonomously adjust the luminous output and operational parameters based on real-time environmental conditions, such as heat, wind, and battery status. This autonomous adjustment may ensure performance and energy efficiency. The spotlight component 702 may also work in conjunction with an autonomous tracking system, which may center the spotlight beam on selected static locations or dynamically moving targets. This system may adjust the UAV's flight parameters, including altitude, position, and orientation, to maintain precise spotlight alignment. Additionally, the spotlight component 702 may be part of a dynamic adjustment system, allowing for real-time adjustments of spotlight pitch and attachment positioning. This system may utilize onboard controls, remote control mechanisms, or autonomous onboard systems responding to sensor feedback and environmental data. These features may collectively enhance the UAV's capability to perform tasks such as search and rescue operations, law enforcement surveillance, and security monitoring.

The Intelligent Modulation System 704 may autonomously adjust the luminous output and operational parameters of the spotlight based on real-time environmental conditions. This system may incorporate intelligent modulation, which may respond to changes in environmental factors such as heat, wind, and battery status. The autonomous adjustment of light output may be facilitated by the system's ability to process real-time data, ensuring illumination performance. The Intelligent Modulation System 704 may be configured to autonomously adjust luminous output and operational parameters, which may include responding to environmental changes. This capability may allow the system to maintain operation under varying conditions, thereby enhancing the UAV's overall functionality. The system may also be capable of incorporating additional components, such as sensors and data processing units, which may not be explicitly mentioned but are essential for the system's operation. These components may work together to ensure that the spotlight delivers consistent illumination, even in challenging environments. The Intelligent Modulation System may thus play a role in the UAV's ability to perform tasks such as search and rescue operations, law enforcement surveillance, and emergency response scenarios, where reliable illumination is needed.

The Autonomous Tracking System 706 may be integral to the UAV's operational capabilities. This system may be configured to autonomously center the spotlight beam on selected static locations or dynamically moving targets. The selection of these targets may occur via user inputs or automated algorithms, allowing for flexibility in operation. The system may adjust the UAV's flight parameters, which may include altitude, position, and orientation, to maintain precise spotlight alignment on the targets. This adjustment may ensure continuous illumination, which may be beneficial for applications such as search and rescue operations or law enforcement surveillance. The Autonomous Tracking System 706 may work in conjunction with other systems to provide a solution for target tracking and illumination. The system's ability to autonomously adjust flight parameters may enhance the UAV's capability to maintain focus on the target, thereby optimizing the spotlight's effectiveness. The integration of this system may allow for seamless operation, reducing the need for manual intervention and potentially increasing the efficiency of the UAV in various scenarios.

The Dynamic Adjustment System 708, may facilitate dynamic, real-time adjustments of the spotlight pitch and attachment positioning within the UAV system. This system may incorporate onboard controls, remote control mechanisms, or autonomous onboard systems that respond to sensor feedback and environmental data. The dynamic adjustment system may be configured to allow these adjustments, which may be important for maintaining illumination and alignment of the spotlight during UAV operation. The system may enable the UAV to adapt to varying conditions by adjusting the spotlight's pitch and the attachment's positioning, thereby ensuring that the spotlight remains aligned with the target. This capability may be particularly beneficial in scenarios where the UAV is required to track moving targets or adjust to changing environmental conditions. The dynamic adjustment system may work in conjunction with other systems, such as the intelligent modulation system and the autonomous tracking system, to provide a solution for UAV-based illumination tasks. By allowing for real-time adjustments, the dynamic adjustment system may enhance the UAV's ability to perform tasks such as search and rescue operations, law enforcement surveillance, and emergency response scenarios, where precise and adaptable illumination is needed.

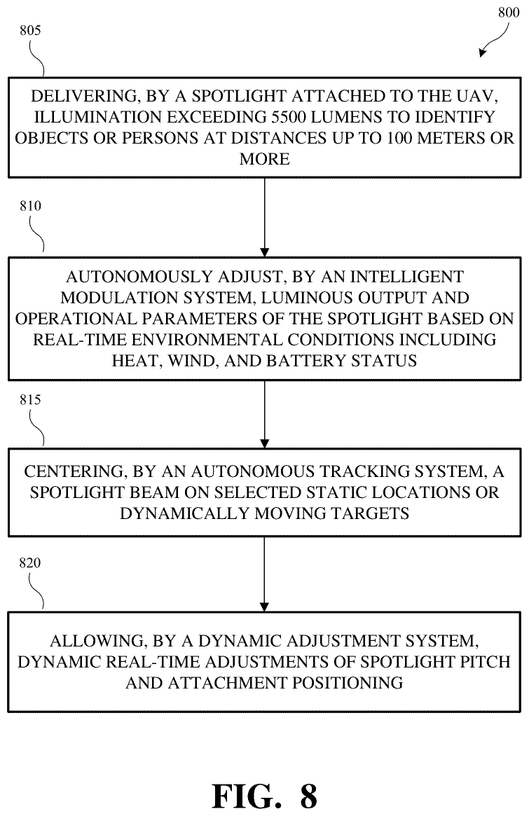

FIG. 8 is a flowchart illustrating a method 800 for delivering illumination using a spotlight attachment on an unmanned aerial vehicle (UAV), according to an embodiment. At step 805, the spotlight attachment may be configured to deliver illumination exceeding 5500 lumens, which can be used to identify objects or persons at distances greater than 100 meters. The spotlight attachment may include adjustable spotlight angles that can be manually pre-set before flight or dynamically adjusted remotely during UAV operation. The spotlight may be part of a system that incorporates intelligent modulation, which can autonomously adjust the luminous output and operational parameters based on real-time environmental conditions, such as heat, wind, and battery status. This adjustment may ensure performance and energy efficiency. The spotlight attachment may also feature an autonomous tracking system that can center the spotlight beam on selected static locations or dynamically moving targets. This system may adjust the flight parameters of the UAV, including altitude, position, and orientation, to maintain precise spotlight alignment on the targets. The selection of targets may occur via user inputs or automated algorithms, allowing for flexibility in operation. Additionally, the spotlight attachment may include a dynamic adjustment system that allows for real-time adjustments of spotlight pitch and attachment positioning. This system may comprise onboard controls, remote control mechanisms, or autonomous onboard systems that respond to sensor feedback and environmental data, enabling the UAV to adapt to changing conditions and maintain effective illumination.

At step 810, the intelligent modulation system may autonomously adjust the luminous output and operational parameters of the spotlight. This adjustment may be based on real-time environmental conditions, which can include factors such as heat, wind, and battery status. The intelligent modulation system may incorporate intelligent modulation to facilitate these adjustments. The spotlight may have adjustable spotlight angles that can be manually pre-set before flight or dynamically adjusted remotely during UAV operation. This capability may allow for the spotlight to be directed as needed, enhancing the UAV's operational flexibility. The intelligent modulation system may respond to environmental changes, ensuring that the spotlight's performance is optimized for the current conditions. This autonomous adjustment may be important for maintaining the desired level of illumination and operational efficiency, regardless of the environmental challenges encountered during the UAV's mission.

At step 815, the autonomous tracking system may be employed to center a spotlight beam on selected static locations or dynamically moving targets. This process may involve the autonomous tracking system adjusting the flight parameters of the UAV to maintain precise spotlight alignment on the selected targets. The flight parameters may include altitude, position, and orientation of the UAV, which can be important for ensuring that the spotlight remains focused on the intended target. The selection of static locations or dynamically moving targets may be facilitated by user inputs or automated algorithms, allowing for flexibility in operation. The autonomous tracking system may utilize these inputs to determine the most effective way to keep the spotlight centered on the target, thereby enhancing the UAV's ability to illuminate specific areas or objects. This capability may be particularly useful in scenarios where continuous illumination of a target is required, such as in search and rescue operations or surveillance activities. The integration of these functionalities within the UAV system may provide a solution for maintaining spotlight alignment and ensuring effective illumination of targets.

In the context of step 820, the focus is on the dynamic adjustment system that may allow for real-time modifications of the spotlight pitch and attachment positioning. This system may comprise various control mechanisms, including onboard controls, remote control mechanisms, or autonomous onboard systems that respond to sensor feedback and environmental data. The dynamic adjustment system may be designed to facilitate the adaptation of the spotlight's orientation and positioning in response to changing conditions, thereby enhancing the UAV's operational flexibility. The system may utilize sensor feedback to assess environmental conditions and make necessary adjustments to maintain spotlight performance. This capability may be particularly beneficial in scenarios where precise illumination is required, such as search and rescue operations or surveillance tasks. The integration of such a dynamic adjustment system may ensure that the spotlight can be effectively directed and repositioned as needed, thereby supporting the UAV's ability to perform its intended functions efficiently.

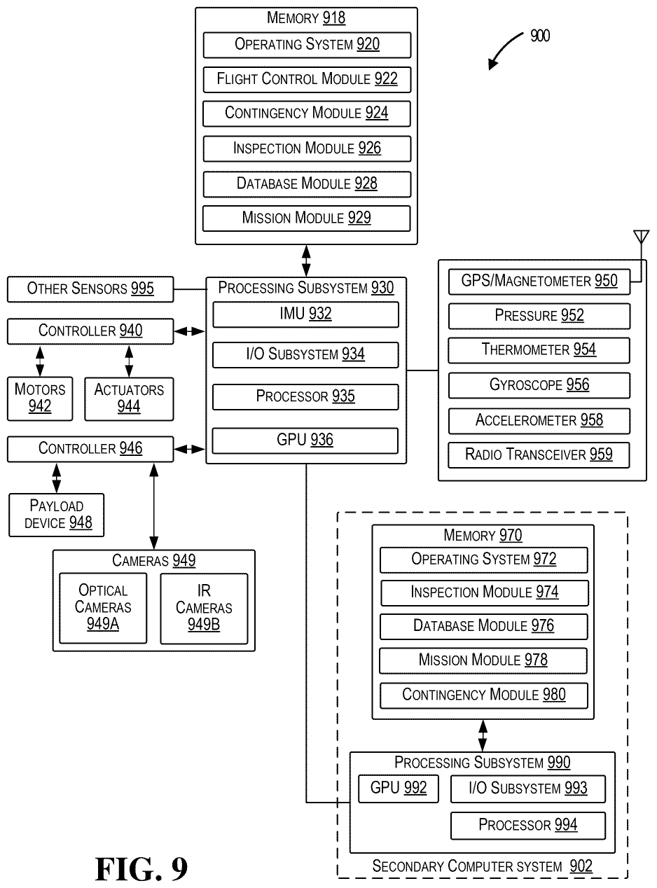

FIG. 9 illustrates an example UAV architecture for a UAV, consistent with various embodiments. A UAV can include a primary computer system 900 and a secondary computer system 902. The UAV primary computer system 900 can be a system of one or more computers, or software executing on a system of one or more computers, which is in communication with, or maintains, one or more databases. The UAV primary computer system 900 can include a processing subsystem 930 including one or more processors 935, graphics processing units 936, I/O subsystem 934, and an inertial measurement unit (IMU) 932. In addition, the UAV primary computer system 900 can include logic circuits, analog circuits, associated volatile and/or non-volatile memory, associated input/output data ports, power ports, etc., and include one or more software processes executing on one or more processors or computers. The UAV primary computer system 900 can include memory 918.

Memory 918 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 900 may be coupled to one or more sensors, such as global navigation satellite system (GNSS) receivers 950 (e.g., GPS receivers), thermometer 954, gyroscopes 956, accelerometers 958, pressure sensors (static or differential) 952, and other sensors 995 that capture perception inputs of a physical environment. The other sensors 995 can include current sensors, voltage sensors, magnetometers, hydrometers, anemometers and motor sensors. The UAV may use IMU 932 in inertial navigation of the UAV. Sensors can be coupled to the UAV primary computer system 900, or to controller boards coupled to the UAV primary computer system 900. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 900 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 922 handles flight control operations of the UAV. The module interacts with one or more controllers 940 that control operation of motors 942 and/or actuators 944. For example, the motors may be used for rotation of propellers, and the actuators may be used for flight surface control such as ailerons, rudders, flaps, landing gear and parachute deployment.

The contingency module 924 monitors and handles contingency events. For example, the contingency module 924 may detect that the UAV has crossed a boundary of a geofence, and then instruct the flight control module 922 to return to a predetermined landing location. The contingency module 924 may detect that the UAV has flown or is flying out of a visual line of sight (VLOS) from a ground operator, and instruct the flight control module 922 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 929 processes the flight plan, waypoints, and other associated information with the flight plan as provided to the UAV in a flight package. The mission module 929 works in conjunction with the flight control module 922. For example, the mission module may send information concerning the flight plan to the flight control module 922, for example waypoints (e.g., latitude, longitude and altitude), flight velocity, so that the flight control module 922 can autopilot the UAV.

The UAV may have various devices connected to the UAV for performing a variety of tasks, such as data collection. For example, the UAV may carry one or more cameras 949. Cameras 949 can include one or more visible light cameras 949A, which can be, for example, a still image camera, a video camera, or a multispectral camera. The UAV may carry one or more infrared cameras 949B. Each infrared camera 949B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 918 of the UAV primary computer system 900.

The UAV primary computer system 900 may be coupled to various radios, e.g., transceivers 959 for manual control of the UAV, and for wireless or wired data transmission to and from the UAV primary computer system 900, and optionally a UAV secondary computer system 902. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 920 and storing the information in computer-readable media (e.g., non-volatile memory 918). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 920. In some implementations, the operating system 920 can be a real time operating system (RTOS), UNIX, LINUX, OS X, WINDOWS, ANDROID or other operating system 920. Additionally, other software modules and applications may run on the operating system 920, such as a flight control module 922, contingency module 924, inspection module 926, database module 928 and mission module 929. In particular, inspection module 926 can include computer instructions that, when executed by processor 935, can cause processor 935 to control the UAV to perform solar panel inspection operations as described below. Typically, flight critical functions will be performed using the UAV primary computer system 900. Operating system 920 may include instructions for handling basic system services and for performing hardware dependent tasks.

In addition to the UAV primary computer system 900, the secondary computer system 902 may be used to run another operating system 972 to perform other functions. The UAV secondary computer system 902 can be a system of one or more computers, or software executing on a system of one or more computers, which is in communication with, or maintains, one or more databases. The UAV secondary computer system 902 can include a processing subsystem 990 of one or more processors 994, GPU 992, and I/O subsystem 993. The UAV secondary computer system 902 can include logic circuits, analog circuits, associated volatile and/or non-volatile memory, associated input/output data ports, power ports, etc., and include one or more software processes executing on one or more processors or computers. The UAV secondary computer system 902 can include memory 970. Memory 970 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 902 will be non-critical functions in nature. If the function fails, the UAV will still be able to operate safely. The UAV secondary computer system 902 can include operating system 972. In some implementations, the operating system 972 can be based on real time operating system (RTOS), UNIX, LINUX, OS X, WINDOWS, ANDROID or other operating system.

Additionally, other software modules and applications may run on the operating system 972, such as an inspection module 974, database module 976, mission module 978 and contingency module 980. In particular, inspection module 974 can include computer instructions that, when executed by processor 994, can cause processor 994 to control the UAV to perform solar panel inspection operations as described below. Operating system 972 may include instructions for handling basic system services and for performing hardware dependent tasks.

The UAV can include controllers 946. Controllers 946 may be used to interact with and operate a payload device 948, and other devices such as cameras 949A and 949B. Cameras 949A and 949B can include a still-image camera, video camera, infrared camera, multispectral camera, stereo camera pair. In addition, controllers 946 may interact with a Lidar, radio transceiver, sonar, laser ranger, altimeter, TCAS, ADS-B (Automatic dependent surveillance—broadcast) transponder. Optionally, the secondary computer system 902 may have controllers to control payload devices.

The UAV 100 illustrated in FIGS. 1-6 is an example provided for illustrative purposes. The UAV 100 in accordance with the present disclosure may include more or fewer components than are shown. For example, while a quadcopter is illustrated, the UAV 100 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 100 may be guided by other types of vehicles (e.g., spacecraft, land vehicles, watercraft, submarine vehicles, etc.).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

What is claimed is:

1. A spotlight attachment for an unmanned aerial vehicle (UAV), comprising:
a spotlight configured to deliver illumination exceeding 5500 lumens to identify objects or persons at distances greater than 100 meters; and
an intelligent modulation system configured to autonomously adjust luminous output and operational parameters of the spotlight based on real-time environmental conditions including heat, wind, and battery status.

2. The spotlight attachment of claim 1, wherein the spotlight comprises adjustable spotlight angles that are manually pre-set before flight or dynamically adjustable remotely during UAV operation.

3. The spotlight attachment of claim 1, further comprising an autonomous tracking system configured to:
center a spotlight beam on selected static locations or dynamically moving targets; and
adjust flight parameters of the UAV to maintain precise spotlight alignment on the selected static locations or dynamically moving targets.

4. The spotlight attachment of claim 3, wherein the autonomous tracking system is configured to select the static locations or dynamically moving targets via user inputs or automated algorithms.

5. The spotlight attachment of claim 3, wherein the flight parameters comprise altitude, position, and orientation of the UAV.

6. The spotlight attachment of claim 1, further comprising:
a dynamic adjustment system configured to allow dynamic real-time adjustments of spotlight pitch and attachment positioning.

7. The spotlight attachment of claim 6, wherein the dynamic adjustment system comprises at least one of onboard controls, remote control mechanisms, or autonomous onboard systems responding to sensor feedback and environmental data.

8. An unmanned aerial vehicle (UAV) system, comprising:
a UAV; and
a spotlight attachment coupled to the UAV, the spotlight attachment including:
a spotlight configured to deliver illumination exceeding 5500 lumens to identify objects or persons at distances greater than 100 meters; and
an intelligent modulation system configured to autonomously adjust luminous output and operational parameters of the spotlight based on real-time environmental conditions including heat, wind, and battery status.

9. The UAV system of claim 8, wherein the spotlight comprises adjustable spotlight angles that are manually pre-set before flight or dynamically adjustable remotely during UAV operation.

10. The UAV system of claim 8, further comprising:
an autonomous tracking system including:
center a spotlight beam on selected static locations or dynamically moving targets; and
adjust flight parameters of the UAV to maintain precise spotlight alignment on the selected static locations or dynamically moving targets.

11. The UAV system of claim 10, wherein the autonomous tracking system is configured to select the static locations or dynamically moving targets via user inputs or automated algorithms.

12. The UAV system of claim 10, wherein the flight parameters comprise altitude, position, and orientation of the UAV.

13. The UAV system of claim 8, further comprising:
a dynamic adjustment system configured to allow dynamic real-time adjustments of spotlight pitch and attachment positioning.

14. The UAV system of claim 13, wherein the dynamic adjustment system comprises at least one of onboard controls, remote control mechanisms, or autonomous onboard systems responding to sensor feedback and environmental data.

15. A method for illuminating objects or persons using an unmanned aerial vehicle (UAV), the method comprising:
delivering, by a spotlight attached to the UAV, illumination exceeding 5500 lumens to identify objects or persons at distances greater than 100 meters; and
autonomously adjusting, by an intelligent modulation system, luminous output and operational parameters of the spotlight based on real-time environmental conditions including heat, wind, and battery status.

16. The method of claim 15, further comprising:
manually pre-setting or dynamically adjusting spotlight angles of the spotlight before flight or remotely during UAV operation.

17. The method of claim 15, further comprising:
centering, by an autonomous tracking system, a spotlight beam on selected static locations or dynamically moving targets; and
adjusting, by the autonomous tracking system, flight parameters of the UAV to maintain precise spotlight alignment on the selected static locations or dynamically moving targets.

18. The method of claim 17, further comprising:
selecting, by the autonomous tracking system, the static locations or dynamically moving targets via user inputs or automated algorithms.

19. The method of claim 17, wherein the flight parameters comprise altitude, position, and orientation of the UAV.

20. The method of claim 15, further comprising:
allowing, by a dynamic adjustment system, dynamic real-time adjustments of spotlight pitch and attachment positioning,
wherein the dynamic adjustment system comprises at least one of onboard controls, remote control mechanisms, or autonomous onboard systems responding to sensor feedback and environmental data.
